(19) United States
(12) Patent Application Publication
(10) Pub. No.: US 2025/0381541 A1
(43) Pub. Date: Dec. 18, 2025

(54) Hydrogen Generation via Water Reactive Fuels

(71) Applicant: Tactical Edge Systems, Inc., Billerica, MA (US)

(72) Inventor: Mark Donahue, Littleton, MA (US)

(21) Appl. No.: 19/239,597

(22) Filed: Jun. 16, 2025

Related U.S. Application Data
(60) Provisional application No. 63/660,251, filed on Jun. 14, 2024.

(51) Int. Cl. B01J 8/00; B01J 8/08; C01B 3/08

(52) U.S. Cl. CPC B01J 8/002; B01J 8/08; C01B 3/08; B01J 2208/00752

(57) ABSTRACT

An apparatus for generating Hydrogen from a water reactive fuel is provided. The apparatus can include a cylindrical tube having a first end and a closed second end opposite the first end. The cylindrical tube can include a plurality of cylindrical containers arranged in a stacked configuration within the cylindrical tube and retaining a water reactive fuel therein. Each cylindrical container can have an open first end and a closed second end opposite the open first end. At least one of the open first end and the closed second end of a first cylindrical container can include a gasket therearound configured to seal the water reactive fuel of a second cylindrical container adjacent to the first cylindrical container within the cylindrical tube. Related systems and methods are also provided.

### CROSS-REFERENCE TO RELATED APPLICATIONS

This application claims priority to U.S. Provisional Patent Application No. 63/660,251 filed Jun. 14, 2024, entitled “Water Reactive Fuel Injection,” which is hereby incorporated herein by reference in its entirety.

### TECHNICAL FIELD

The subject matter described herein relates to Hydrogen generation using water reactive fuels.

### BACKGROUND

Hydrogen gas can provide a number of advantages as an alternative fuel source for a variety of applications. Hydrogen gas has a significantly higher energy-to-mass ratio compared to traditional energy sources like gasoline or lithium-ion batteries and can be produced for use in remote locations on applications in which other energy sources are impractical.

Hydrogen can be generated from water reactive fuels by wetting or otherwise contacting the water reactive fuel with a reaction medium. The evolved Hydrogen gas can be captured and utilized as a fuel source for various applications.

### SUMMARY

In general, systems, apparatuses, and methods for generating Hydrogen from a water reactive fuel are provided. In one aspect, a system is provided and in one embodiment, the system can include a reactor vessel that can have at least one wall and retaining a reaction medium therein. The system can also include a fuel storage assembly that can be releasably coupled an opening in the at least one wall of the reactor vessel. The fuel storage assembly can include water reactive fuel configured to react with the reaction medium and to generate Hydrogen. The system can also include an actuator coupled to the fuel storage assembly. The actuator can be configured to supply an actuation force to the fuel storage assembly to cause the water reactive fuel to be dispensed from the fuel storage assembly, through the opening in the at least one wall, and into the reactor vessel.

One or more of the following features can be configured based on the descriptions herein. For example, in some embodiments, the fuel storage assembly can include a tube having an open first end and a closed second end opposite the open first end. The open first end can have a flange therearound configured to releasably couple the open first end to a collar positioned in the opening in the at least one wall of the reactor vessel. In some embodiments, the closed second end can include a plate configured to couple with the actuator and to receive the actuation force. The plate can include a first side and a second side opposite the first side. At least one of the first side and the second side can include a gasket therearound configured to seal the plate within the fuel storage assembly.

In other embodiments, the actuator can include one of a linear actuator, a pressurized air supply, or a pneumatic injection device. In some embodiment, the fuel storage assembly can include a plurality of containers. Each container can retain a predetermined amount of the water reactive fuel configured to form the generated Hydrogen when dispensed from the fuel storage assembly into the reaction medium. In other embodiments, at least one container of the plurality of containers can include an open first end, a bottom wall opposite the open first end, and a side wall extending between the open first end and the bottom wall. In some embodiments, at least one of the open first end and the bottom wall can include a gasket therearound configured to seal the water reactive fuel within the at least one container within the fuel storage assembly.

In other embodiments, the predetermined amount of the water reactive fuel is between 50 grams and 100 grams. In some embodiments, the at least one wall of the reactor vessel to which the fuel storage assembly can be coupled can include a removable flange portion configured to remove the at least one wall from the plurality of walls of the reactor vessel. In other embodiments, the at least one wall can further include a displacement mechanism positioned adjacent to the opening in the at least one wall of the reactor vessel and protruding into the reactor vessel. In some embodiments, the displacement mechanism can include an engagement member configured to axially displace a container of the fuel storage assembly from the opening in the at least one wall of the reactor vessel. In other embodiments, the actuator can be configured to supply the actuation force responsive to a control signal received from a controller operably coupled to the actuator.

In another aspect, an apparatus is provided and in one embodiment, the apparatus can include a cylindrical tube having a first end and a closed second end opposite the first end. The cylindrical tube can include a plurality of cylindrical containers arranged in a stacked configuration within the cylindrical tube and retaining a water reactive fuel therein. Each cylindrical container can have an open first end and a closed second end opposite the open first end. At least one of the open first end and the closed second end of a first cylindrical container can include a gasket therearound configured to seal the water reactive fuel of a second cylindrical container adjacent to the first cylindrical container within the cylindrical tube.

One or more of the following features can be configured based on the descriptions herein. For example, in some embodiments, at least one cylindrical container of the plurality of cylindrical containers can retain between 50 and 100 grams of the water reactive fuel therein. In other embodiments, the closed second end can include a plate having a first wall and a second wall forming the closed second end of the cylindrical tube. The second wall can be configured to receive an actuation force to cause at least one cylindrical container to advance through the cylindrical tube toward the first end thereof. In some embodiments, the actuation force can be supplied via at least one of a linear actuator, a pressurized air supply, and a pneumatic injection system. In other embodiments, the first end of the cylindrical tube can include a flange extending circumferentially therearound. The flange can be configured to couple the cylindrical tube with a wall of a reactor vessel comprising a reaction medium.

In some embodiments, the water reactive fuel can be configured to generate Hydrogen when dispensed from a cylindrical container that has translated through the first end of the cylindrical tube and into the reactor vessel so as to contact the reaction medium. In other embodiments, the first end of the cylindrical tube can further include a seal extending thereacross to seal the water reactive fuel within the cylindrical tube, the seal configured to unseal responsive to translating a cylindrical container through the first end.

In another aspect, a method is provided and in one embodiment, the method can include coupling a first end of a fuel storage assembly containing a plurality of containers retaining a water reactive fuel to at least one wall of a reactor vessel retaining a reaction medium. The method can also include causing at least one container to translate through the first end of the fuel storage assembly and into the reactor vessel so as to dispense the water reactive fuel within the reaction medium. The method can further include generating Hydrogen gas evolved from the water reactive fuel dispensed in the reaction medium. The method can also include collecting the generated Hydrogen gas via a collection port of the reactor vessel.

### DESCRIPTION OF DRAWINGS

FIG. 1 illustrates an example implementation of a system for generating Hydrogen from a water reactive fuel;

FIG. 2 illustrates three configurations of the system of FIG. 1;

FIG. 3 illustrates another example implementation of a system for generating Hydrogen from a water reactive fuel including a control manifold and a fuel storage assembly;

FIG. 4 illustrates an example implementation of a fuel storage assembly configured for use in another implementation of a system for generating Hydrogen from a water reactive fuel;

FIG. 5 illustrates another example implementation of a system for generating Hydrogen from a water reactive fuel dispersed into a reactor vessel using the fuel storage assembly of FIG. 4;

FIG. 6 illustrates an example implementation of the system of FIG. 5 dispensing a water reactive fuel into the reactor vessel from a container of the fuel storage assembly of FIG. 4;

FIG. 7 illustrates an example implementation of the system of FIG. 5 including a displacement mechanism configured to displace containers of the fuel storage assembly of FIG. 4 within the reactor vessel; and

FIG. 8 illustrates a process diagram illustrating an example implementation of a method for generating Hydrogen from a water reactive fuel using the system of FIG. 5.

Like reference symbols in the various drawings indicate like elements.

### DETAILED DESCRIPTION

Hydrogen can be generated from water reactive fuels by exposing the water reactive fuel to a reaction medium, such as water. In order to consume the water reactive fuel efficiently and to maintain generation of Hydrogen at desired levels, care must be taken to ensure sufficient amounts of water reactive fuel are exposed to the reaction medium in a timely manner and that the water reactive fuel is not prematurely exposed to water or otherwise consumed prior to its use for Hydrogen generation.

Hydrogen can be produced from water reactive fuels in a reactor vessel containing the reaction medium, such as water. Introducing the water reactive fuel into the reactor vessel and maintaining sufficient Hydrogen production from the water reactive fuel in reactor vessels can be difficult to perform in a repeatable, consistent manner without using complex, laboratory-scale reactor vessels or manual dosing techniques, which may not be suitable for Hydrogen generation applications in which the size and deployment conditions of the reactor vessel and fuel dispersion techniques can be limiting. For example, configuring smaller-scale reactor vessels for Hydrogen generation can be challenging due to the need to preserve the water reactive fuel from being prematurely wetted and the need to feed the water reactive fuel into the reactor vessel at sufficient dosing or amounts needed to maintain Hydrogen generation over prolonged periods of time and with minimal manual intervention. A need exists for systems and methods to generate Hydrogen using water reactive fuels that provide for conservation of the water reactive fuels and automated dosing of the water reactive fuels into a reaction medium to create a robust, sustainable supply of Hydrogen as a fuel source.

The systems and methods described herein enable Hydrogen generation using water reactive fuels and are configured to address the aforementioned issues. Additionally, the systems and methods described herein can be configured in a low-foot print, configurable manner in which water reactive fuels are maintained dry until use and can be fed into the reactor vessel in a continuous, automated manner to ensure ongoing Hydrogen production for use as a fuel source in a variety of applications which require easy administration of the water reactive fuels and small-scale reactor vessels that are easy to configure and deploy.

The systems and methods described herein can utilize water reactive fuel injection to disperse a water reactive fuel into water. In some embodiments, the water reactive fuel can include Aluminum, Magnesium, or a nanoporous Silicon. In such embodiments, a reaction equation for Aluminum dispersed into or wetted by water can be defined as: 6H₂O+2Al->3H₂+2 Al(OH) 3+Q. Thus, water (H₂O) will react with aluminum (Al) to produce Hydrogen (H₂) and Aluminum hydroxide (Al(OH)₃) as well as heat (Q), which results from the splitting of the water's chemical bonds.

Approximately half of the energy that is released is released in the form of Hydrogen, the remaining portion of the released energy is released as heat. Heat is generated as a result of breaking the chemical bonds of the water molecules. Various formulations of fuel materials, reactor designs, and operating conditions will cause the reaction to proceed at different rates. Reaction rates can vary from reactions that occur over a period of seconds to reactions that occur over a period of hours. The reaction can yield Aluminum hydroxide that can be released as a powder. The Al(OH)₃ powder can be suspended in the water, as Al(OH)₃ is not water soluble and can appear as a blended mixture of the Al(OH)₃ in the water. When left overnight most of the Al(OH)₃ will settle to the bottom of a storage vessel leaving the water above the Al(OH)₃ clear.

During the reaction, Hydrogen (H₂) and steam can also be released. The H₂ and steam can be released from the surface of the aluminum. The released H₂ and steam can propagate upwards through the solution of Al(OH)₃ and water. As the reaction proceeds, especially at faster reaction rates, the density of the solution of Al(OH)₃ and water will cause the H₂ and steam to move more slowly through the solution of Al(OH)₃ and water. Depending on the surface tension of the solution of Al(OH)₃ and water, as well as the amount of aluminum fuel or fuel material that was reacted with the water in a given injection or over a period of time, the H₂ and steam can form bubbles. The bubbles of H₂ and/or steam can range in size. In some embodiments, the bubbles of H₂ and/or steam can be small and ubiquitous. In some embodiments, the bubbles of H₂ and/or steam can be large. It is not uncommon for the volume of the resulting mixture to appear to double or triple as a result of the bubbles that are formed.

As the reaction proceeds further, various conditions can cause the aluminum fuel or material to “float” on the resultant Al(OH)₃ solution, which can reduce the generation of Hydrogen from the water reactive fuel. For example, if the water reactive fuel floats on top of the reaction byproduct (Al(OH)₃), then that byproduct isolates the fuel from the water in the reactor vessel below and the fuel will not continue to react with the water to generate Hydrogen. The activated fuel relies on roiling and access to fresh water to rinse away the Al(OH)₃ so that the reaction is not “starved.” At some point the Al(OH)₃ filled water will prevent newly added aluminum from submerging and dissociating properly into Hydrogen gas.

To address, this issue the water reactive fuel can be injected below the waterline of the reactor vessel. In some embodiments, the water reactive fuel or material can be injected near a bottom of a reaction vessel or reactor. This method can provide the best probability of sufficiently wetting of the aluminum fuel or material. Injecting the water reactive fuel at or near the bottom of a reaction vessel, then the fuel is much more likely to encounter or be surrounded by sufficiently fresh water in order for the water reactive fuel to fully react therein. Also, the energy of the reaction can also cause churning in the reaction medium which can disperse the Al(OH)₃ byproduct and continue to allow sufficient water to contact the fuel.

In some embodiments, the amount of Al that is floating in the Al(OH)₃ solution can be mitigated using a large hopper of water reactive fuel or material and dispensing (or dosing) a small or fixed amounts of the water reactive fuel or material at a time into a reaction vessel or reactor above a level of the water and/or any floating water reactive fuel or material that may be present in the reaction vessel or reactor. Advantageously, managing the dispensing of small or fixed amounts of the water reactive fuel or material can result in longer reaction times and a slower release rate of Hydrogen and/or steam.

However, embodiments of the aforementioned method(s) to mitigate amounts of Al floating in the Al(OH)₃ solution can also include challenges. In some embodiments, the steam produced during the reaction can propagate to a location at which the water reactive fuel or material is stored (e.g., such as a location within a dispensing system or dispensing device configured to dispense the water reactive fuel or material. As a result, the water reactive fuel or material at that location can react with the generated steam and can produce a paste material that is thick and viscous (e.g., a sludge-like material) that can cause the dispensing system or dispensing device to stop working. For example, the paste material can build up at an outlet of the dispenser and can clog the dispenser to prevent fuel from entering the reactor vessel as intended.

To maintain the reaction in efficient and continuous operation, it can be important to manage the thermal conditions of the system. For example, minimizing steam production can be important to avoid excessive temperature buildup. Proper wetting of the water reactive fuel can also be more challenging when less water is available in the reactor vessel. While some water is consumed during the reaction (e.g., as the source of the Hydrogen), additional amounts of water can be necessary to cool the reaction vessel or the reactor. Additionally, additional amounts of water can be applied to keep the bulk-temperature of the water in the reaction vessel or reactor below or close to its boiling point in order to reduce the quantity of steam produced in the reaction. Yet, in some embodiments, supplying additional amounts of water for reactor cooling and/or reduced steam generation can present logistical problems as additional amounts of water may be inaccessible in some environments. In some embodiments, the volume, mass, and/or physical footprint of a water-supply system for reactor cooling and/or reduced steam generation can be a non-trivial design feature requiring complex fluidic devices or systems.

There are additional considerations for designing a water reactive fuel reactor. For example, the reactive fuel or material should be kept dry until ready to be injected into the reaction vessel or reactor in order to increase or maximize the amount of Hydrogen produced. It can also be important to manage temporal aspects of the reaction. For example, it is best to avoid evolving or generating Hydrogen from the reactive fuel or material until it is in a Hydrogen ready container, such as a reaction vessel or reactor. Additionally, in some aspects, it can be advantageous to stop the evolution or generation of Hydrogen. Extracting un-reacted fuel or material can also be challenging and can be an important safety consideration for operators of the reaction vessel or reactor. Considerations should also be given to the physical arrangement of components in a water reactive fuel system or device. For example, a hopper style dispensing system or device containing unprotected reactive fuel or material that is connected to a water chamber of a reaction vessel or reactor can be vulnerable to tipping over or loss of water from the reaction vessel or reactor. Such incidents can result in a catastrophic failure of the dispensing system or device, as well as the reaction vessel or reactor.

Hydrogen is a flammable and potentially explosive gas. Below a certain concentration Hydrogen will not ignite, even in the presence of oxygen. For example, a concentration of Hydrogen in the range of parts per million will not ignite. Likewise, above a certain concentration Hydrogen also will not ignite. In such conditions, the Hydrogen will not ignite even if the balance of the gas volume contains oxygen. Thus, an improved reaction vessel or reactor design can be configured to limit headspace (e.g., empty air volume) therein in order to reduce the potential for ignition of the Hydrogen gas. Preferably, an improved reaction vessel or reactor design can be configured to evacuate oxygen from the empty air volume within the reaction vessel or reactor. In some embodiments, a vacuum can be configured to evacuate oxygen. In some embodiments, backfilling and/or flowing an inert gas into the reaction vessel or reactor can be performed to evacuate oxygen. For example, a gas heavier than air (e.g., Argon) can be supplied into the reaction vessel or reactor to displace oxygenated air therein. In such embodiments, the backfilled gases may need to be filtered or extracted to generate Hydrogen of high purity. In some embodiments, there can be logistical constraints to accessing and/or moving heavy pressurized tanks of inert gases for use in systems, devices, and methods of Hydrogen generation from water reactive fuels or materials.

Additional considerations for generating or evolving Hydrogen from water reactive fuels or materials can include the need to support low-pressure or high-pressure applications or system configurations. High-pressure systems can pose several unique challenges. For example, increasing the pressure of Hydrogen to a useful pressure (e.g., 5,000 to 10,000 psi) can consumes 10-50% of the available energy and reduce the overall efficiency of the system. In contrast, the systems and methods described herein are configured as a low-pressure system. However, other advantages related to maintaining the water reactive fuel in a dry state and repeatable, measured dosing of the water reactive fuel into the reactor vessel can be applicable and relevant for use in high-pressure systems as well. Additionally, the systems and methods described herein can configure the reactor vessel or reactor for stationary use in confined spaces or for mobile use in small volume form factors. Ideally, generating or evolving Hydrogen from water reactive fuels or materials can be performed using automation to control fuel and reaction supplies, reaction conditions, safety measures, and operational costs.

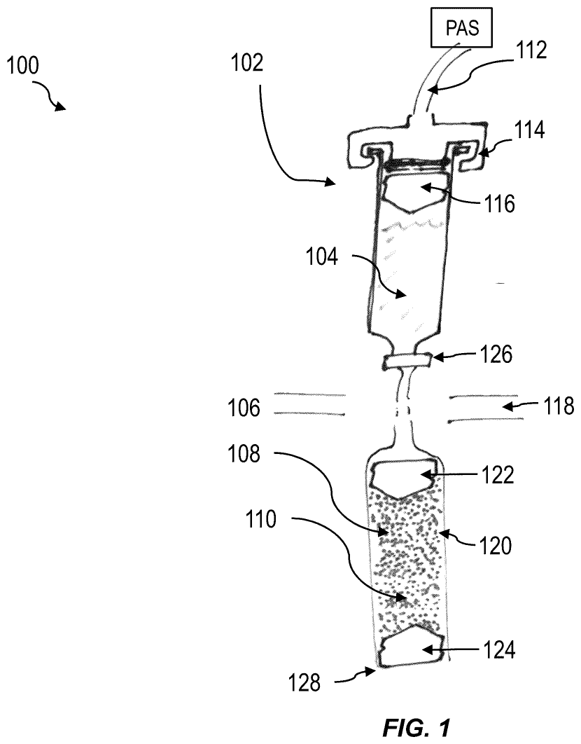

FIG. 1 illustrates an example implementation of a system 100 of the subject matter described herein configured for generating or evolving Hydrogen from water reactive fuels or materials. As shown in FIG. 1, the system 100 can include an injection device 102 having an injection media 104 retained therein, a reactor vessel 106 (of which a cross-sectional view of a wall portion is shown), and a fuel storage device 108 having a water reactive fuel 110 contained therein.

With reference to FIG. 1, the injection device 102 can include tubing 112 fluidically coupled to a fitting 114. In some embodiments, the fitting 114 can be a quick release fitting, although other types of fittings can be envisioned. The tubing 112 can be coupled to a pressurized air source PAS and can convey a supply of pressurized air to the fitting 114. Pressurized air can be generated with common, lightweight, low-power equipment. In some embodiments, pressure can be generated from the PAS using a motorized pump, a hand pump, a fuel cell, or by using the Hydrogen evolved by the system 100 to run in a self-sustaining mode of operation. The injection device 102 can also include a cap 116 configured in the fitting 114. In some embodiments, the cap 3 can include a piston. The cap 116 can be configured to provide separation between the pressurized air received at fitting 114 via tubing 112 from the PAS and the injection media 104 retained within the injection device 102. In some embodiments, the injection media 104 can include water, air, or a pneumatic fluid. In some embodiments, a predetermined volume of injection media 104 can be provided to the reactor vessel 106. It can be advantageous to use an incompressible liquid (e.g., water) as the injection media 104 (and thus the reaction media) to reduce headspace inside the reactor vessel 106.

The system 100 can be configured in a variety of configurations for injecting or dispersing water reactive fuel into the reactor vessel 106. As shown in FIG. 1, a portion of a wall of the reactor vessel 106 is shown. The injection device 102 can be secured to a wall 118 of the reactor vessel 106 via a coupling 126. In some embodiments, the coupling 126 can include a valve configured to control a flow of the injection media 104 exiting the injection device 102. A fuel storage device 108 can be positioned relative to the reactor vessel 106, such as relative to the wall 118 of the reactor vessel 106 and can receive the injection media 104 from the injection device 102 to disperse the water reactive fuel 110 stored in the fuel storage device 108 into a reaction medium contained in the reactor vessel 106. In some embodiments, the reactor vessel 106 can include a low-pressure reactor vessel or a high-pressure reactor vessel. In some embodiments, the reactor vessel 106 can include a metal tank or a plastic tank.

As further shown in FIG. 1, the system 100 can also include a fuel storage device 108. The fuel storage device 108 can contain a water reactive fuel or material 110, such as Aluminum. In some embodiments, the fuel storage device 108 can include 50-200 grams of water reactive fuel. For example, in some embodiments, the fuel storage device 108 can contain between 40-60, 50-70, 60-80, 70-90, 80-100, 90-110, 100-120, 110-130, 120-140, 130-150, 140-160, 150-170, 160-180, 170-190, 180-200, 190-210, or 200-220 grams of water reactive fuel 110, although the fuel storage device 108 can be configured to contain more or less amounts of water reactive fuel 110 without limit. In some embodiments, the size of the fuel storage device 108 and/or the amount of water reactive fuel 110 can depend on the size of the reactor vessel 106 and/or an amount of reaction medium (e.g., water) configured in the reactor vessel 106.

In some embodiments, the fuel storage device 108 can include a tube 120. The tube 120 can include a first piston 122 and a second piston 124 located in the fuel storage device 108 opposite the first piston 122. The pistons 122 and 124 can be configured to provide a water-tight and an air-tight seal of the fuel 110 stored within the tube 120. Components of the fuel storage device 108 can be configured to withstand temperatures associated with generated steam. In some embodiments, the components of the fuel storage device 108 can be configured to withstand temperatures determined by the physics of the reaction between the water reactive fuel and the reaction media (e.g., the boiling point of the reaction media water will rise in some embodiments). The injection device 102 can provide injection media 104 through the reactor vessel wall 118 and into the fuel storage device 108 to push the first piston 122 toward the second piston 124. In this way, the water reactive fuel 110 in the tube 120 is quickly and efficiently wetted by a large mass of the injected media and released from the tube 120 to be dispersed into the reactor vessel 106 to generate Hydrogen therein. In some embodiments, pistons 122 and 124 are disposable. In some embodiments, the pistons 122 and 124 are reusable and can be recovered following use in the tube 120 of the fuel storage device 108. In some embodiments, the pistons 122, 124 can be gaskets, plugs, translating seals or the like that are configured to retain the water reactive fuel 110 within the tube 120 in a sealed configuration and to slidably translate within (e.g., piston 122) the tube 120 or out from (e.g., piston 124) an open end 128 of the tube 120 so as to release the water reactive fuel 110 from within the tube 120 responsive to application of an actuation force supplied to the tube 120 via the injection media 104 retained within the injection device 102.

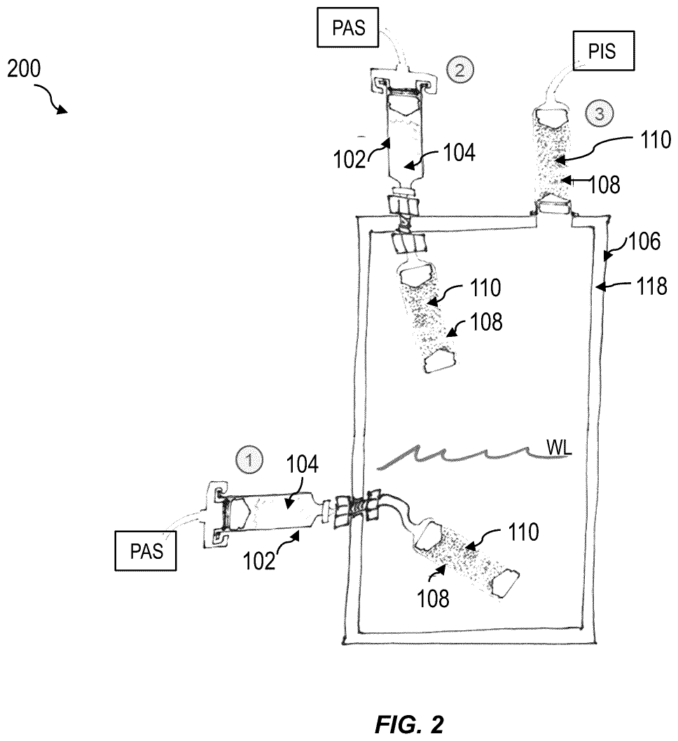

The system 100 of FIG. 1 can be configured in a variety of configurations 200 as shown in FIG. 2. For example, in FIG. 2, three configurations (1, 2 and 3) are illustrated, each utilizing a single fuel storage device 108. In some embodiments, multiple fuel storage devices 108 can be utilized. For example, in some embodiments, tens to hundreds for fuel storage devices 108 can be configured within or relative to a reactor vessel 106.

As shown in configuration 1 of FIG. 2, un-reacted fuel 110 contained within the fuel storage device 108 can be positioned below the water line WL of the reactor vessel 106 until the injection media 104 contained within the injection device 102 is ready to be injected. In this embodiment, the injection device 102 and the fuel storage device 108 are arranged on opposite sides of a wall 118 of the reactor vessel 106. As shown in configuration 1, the reactor vessel 106 can be a low-pressure reactor vessel. For high-pressure applications, penetration would be through the top or bottom of the reactor vessel 106 as shown in configurations 2 and 3.

Injecting the water reactive fuel 110 into the reaction vessel 106 below the water line is ideal for wetting of the fuel and reducing steam (as it travels through the water column). Additionally, cooler water is more prominent at the bottom of the reactor (also reducing evolution of steam). In configuration 1, the amount of water 104 in the injection device 102 is fixed and slightly less than the volume of the fuel 110 in the fuel storage device 108. Compressed air from the PAS can be supplied to the injection device 102 to transfer the water 104 therein to the fuel storage device 108. As water is incompressible, a large force can be applied to achieve a very precise amount of actuation (e.g., movement of the fuel 110 from within the fuel storage device 108 and into the reactor vessel 106. In this way, only the fuel 110, no air, and no extra water 104 is injected into the reactor.

In configuration 2, the fuel storage device 108 is shown above the water surface, but is still positioned inside the reactor vessel 106. The configuration 2 is configured for a pressurized reactor vessel 106. Holes formed in the side wall of a high-pressure reactor vessel can create areas of stress concentration that can ultimately reducing the maximum pressure of the reactor vessel 106. To mitigate this, configuration 2 is configured to inject the water reactive fuel 110 at the top of the reactor vessel 106.

In configuration 3, the fuel storage device 108 is shown outside the reactor vessel 106. The fuel storage device 108 can be inserted into an opening of the reactor vessel 106 and secured in the opening via a threaded coupling or a clamp. In some embodiments, it may be preferable to use pneumatic injection devices or systems (PIS) in place of the injection device 102 to inject the water reactive fuel 110 into the reactor vessel 106. In such embodiments, the fuel storage device 108 can include a fitting, flange, or gasket structure within an inner volume or on an inner surface of the fuel storage device 108 that is configured to retain the first piston 122 within the fuel storage device 108 and to prevent the piston 122 from being displaced from inside the fuel storage device 108. Advantageously, the configuration 3 can limit excess injection gas supplied via the pneumatic injection devices or systems (PIS) from entering the reactor vessel 106.

In some implementations, the injection devices 102 and/or the pressurized air systems (PAS) or the pneumatic injection devices or systems (PIS) can be configured using a bank of solenoids configured to be operably controlled to open air or fluid controlling valves for supplying an air or fluid supply. In some embodiments, replaceable or re-usable packaging can be used for the injection device 102 and/or the fuel storage device 108 to facilitate different requirements of the particular application for Hydrogen generation using the systems and methods described herein. In some embodiments, the fuel storage device 108 can contain 100 grams of water reactive fuel 110, although more or less amounts of water reactive fuel can be envisioned depending on the particular application. In some embodiments, approximately 100 grams of water reactive fuel 110 dispersed into approximately 0.2 liters of water can yield approximately 10 grams of Hydrogen, although additional water can be required for cooling the reaction medium to prevent the formation of steam and additional water reactive fuel 110 may be required to achieve this yield when conditions for the reaction are not 100% efficient.

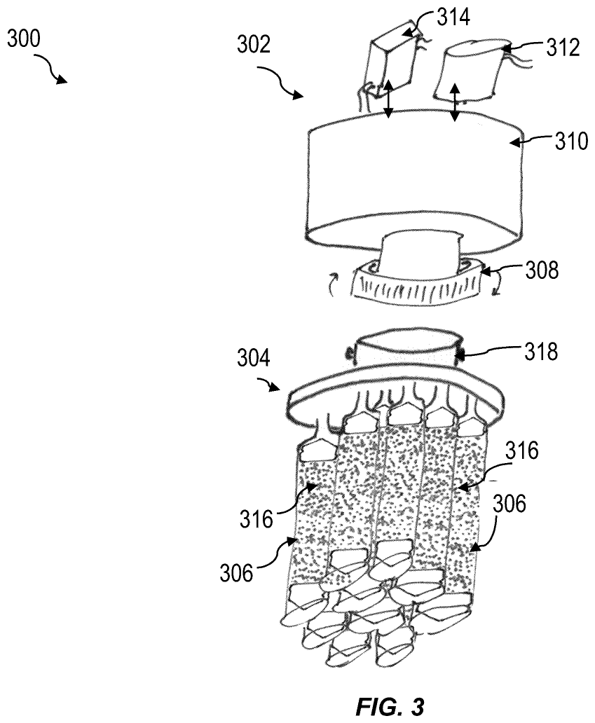

FIG. 3 illustrates another example implementation of the system 100 described in relation to FIGS. 1 and 2. As shown in FIG. 3, the system 300 can include a control manifold 302 that can be fluidically coupled to a fuel storage assembly 304. The fuel storage assembly 304 can include a plurality of individual fuel storage devices 306 corresponding to fuel storage device 108 described in relation to FIGS. 1 and 2.

As shown in FIG. 3, the control manifold 302 includes elements 308-314. The control manifold 302 can include a connector 308 configured to couple the control manifold 302 to a wall 118 of the reactor vessel 106. In some embodiments, the connector 308 can include threaded couplings, snap-fit couplings, friction-fit couplings, detent couplings, latches, or the like. The control manifold 302 can also include a distributor 310 configured to distribute the injection media (such as injection media 104) to any number of the individual fuel storage devices 306 of the fuel storage assembly 304 containing water reactive fuel 316. The distributor 310 can include a plurality of outlet ports that can be fluidically coupled to the connector 308. In some embodiments, the distributor 310 can include a distributor wheel configured therein that can be coupled to an actuated cam configured to open one or more outlet ports at a time. Springs and/or back pressure from within the fuel storage assembly 304 can be used to seal the outlet ports. The distributor 310 can receive injection media 104 from a supply source and can be filled or refilled with injection media 104. One or more sensors and/or actuators, controllable via a control system communicably coupled to the distributor 310 or contained therein can be configured to control the amounts of the injection media 104 that are provided into the respective fuel storage devices 306 of the fuel storage assembly 304. An encoder assembly 312 can be operably coupled to the distributor 310 and can include a motor and an encoder configured to rotate the distributor wheel to positions that are associated with the outlet ports providing fluidic paths into respective fuel storage devices 306 of the fuel storage assembly 304. A solenoid 314 can be coupled to the distributor 310 and can be configured to pressurize (and subsequently vent) the injection media 108 within the distributor 310. In some embodiments, an air compressor and/or a water pump can also be included in the system 300 and can be operably coupled to at least one of the distributor 310 and/or the fuel storage assembly 304.

As shown in FIG. 3, the fuel storage assembly 304 can include a plurality of fuel storage devices 306, corresponding to the fuel storage device 108 described in relation to FIGS. 1 and 2. The fuel storage assembly 304 can be configured as a replaceable unit or a re-usable unit. For example, in some embodiments, the fuel storage assembly 304 can be configured with number of fuel storage devices 306 configured at manufacture. In some embodiments, the fuel storage assembly 304 can be configured with number of fuel storage devices 306 that can be configured to be replaced and/or re-used after manufacture. In some implementations, the plurality of fuel storage devices 306 configured within the fuel storage assembly 304 can be filled with a water reactive fuel or material 316 at a factory during manufacture thereof. In some embodiments, the plurality of fuel storage devices 306 can be filled or refilled with water reactive fuel or material 316 in the field or at a location in which the system 300 is deployed. Some implementations of the current subject matter enables a “fill/refill” approach that moves the task away from the water, steam, and the heat of the reactor 106 thus addressing a number of design limitations.

The aforementioned “fill/refill” approach can describe adding water reactive fuel to the fuel storage devices 306. The use of individual fuel storage devices 306 mitigates problems common in the designs of hopper style fuel injection or dispersion systems. For example, in such systems the water reactive fuel is located in bulk near the reactor and is necessarily connected to the reactor. This configuration can be dangerous for a number of reasons. Initially, retaining water reactive fuel near water is dangerous, especially in the case of accidental spillage or breach of the hopper containing water-reactive fuel, The packing factor or measure of fullness of the water reactive fuel in a reactor vessel is usually about 50%, thus the volume of space around the fuel is initially filled with air. As Hydrogen is evolved it will go into this empty space and result in a mixture of air, the evolved Hydrogen (likely as steam and Hydrogen). This can lead to a dangerous combustive mixture of hydrogen and oxygen. To avoid this hazard, a hopper style system must be vacuum pumped before operation, to remove the air prior to the production of hydrogen. Additionally, an operator is required to fill the water reactive fuel into the hopper on site. This requires attention to detail and dry conditions which are not ideally suited for a system in which outdoor operation and “minimal to no training” are desired objectives. Using fuel storage devices 108, 306 as described herein can enable the fuel storage devices 108, 306 to be filled at the factory, off site from the factory at a deployment location, and/or in a controlled, occupationally-safe and reduced hazard environment. The operator using the systems 100, 300 described herein simply needs to load the injection device 102 (or the control manifold 302) and the fuel storage devices 108 (or the fuel storage assembly 304) onto the reactor vessel 106.

In some embodiments, the fuel storage assembly 304 can include attachment or mating features 318 to fit or otherwise couple the fuel storage assembly 304 to a wall 118 of the reactor vessel 106. In some embodiments, the connector 318 can include threaded couplings, snap-fit couplings, friction-fit couplings, detent couplings, latches, or the like. In some embodiments, the connector 318 can couple the fuel storage assembly 304 to a corresponding attachment or mating feature 308 of the control manifold 302. The individual fuel storage devices 306 can be arranged in a honeycomb formation within the fuel storage assembly 304. Respective fuel storage devices 306 can be coupled to the upper portion of the fuel storage assembly 304 via threaded couplings, twist-lock, snap-fit, or the like. In this way, individual fuel storage devices 306 can be easily removed and replaced.

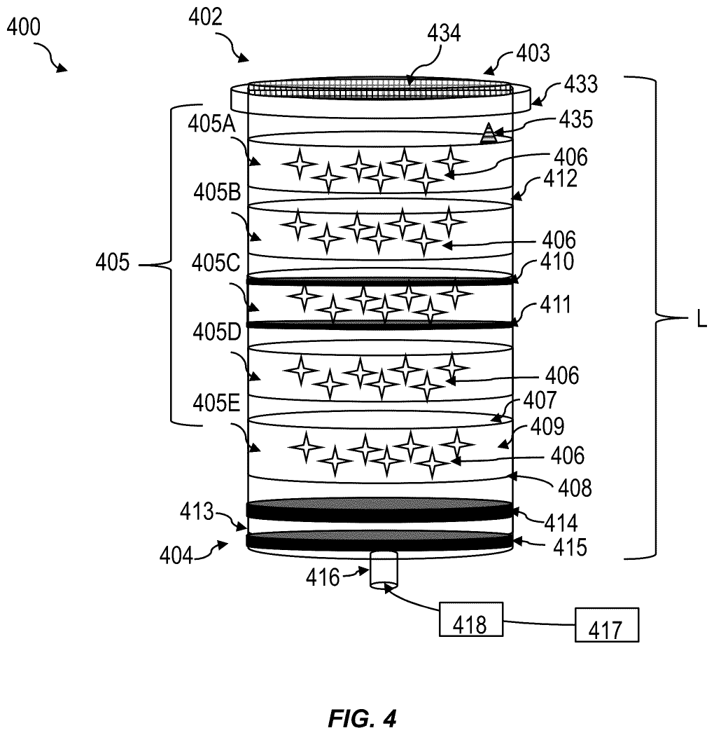

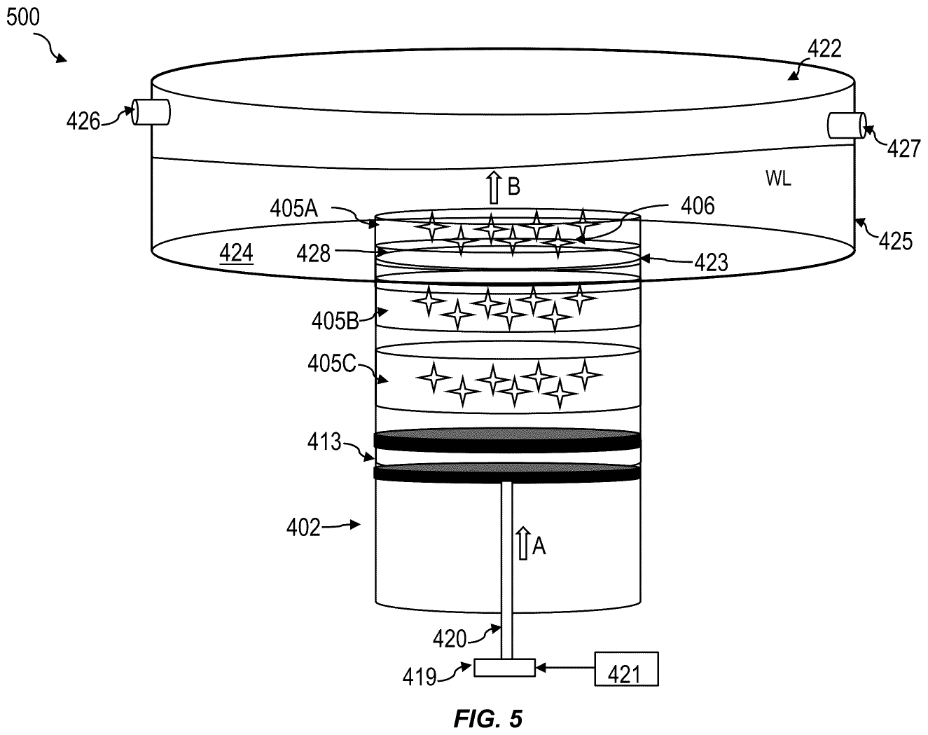

FIG. 4 illustrates another implementation of a fuel storage assembly 400 configured to retain water-reactive fuel therein for Hydrogen generation according to the systems and methods described herein. The fuel storage assembly 400 can be configured for use in the systems 100, 300 except where noted otherwise. As shown in FIG. 4, the fuel storage assembly 400 includes a container 402 having a first end 403 and a second end 404 opposite the first end 403. The first end 403 can be an open first end and can be configured to releasably and sealably couple with a reactor vessel. The second end 404 can be a closed second end. The first end 403 can include a flange 433 protruding from the side walls of the container 402 and extending at least partially around a circumference of the first end 403. The flange 433 can be configured to couple the container 402 to the reactor vessel a reactor vessel 422 shown in FIG. 5.

The container 402 can include a plurality of fuel storage containers 405, such as 405A-405E arranged therein. In some embodiments, the container 402 can include 1, 2, 3, 4, 5, 6, 7, 8, 9, or 10 fuel storage containers 405 therein, in some embodiments, the container 402 can include more fuel storage containers 405. The container 402 can have a substantially cylindrical shape and a hollow interior therein in which one or more of the fuel storage containers 405 can be positioned. The fuel storage containers 405 can include a corresponding cylindrical shape as the container 402. Although the fuel storage assembly 400 is shown configured to include cylindrically-shaped containers 402 and 405, non-cylindrically-shaped containers 402 and 405 can also be envisioned.

In some embodiments, each fuel storage container 405, can include a number of walls enclosing an amount of water-reactive fuel 406 stored therein. For example, as shown with reference to container 405E, the containers 405 can include a top opening 407, a bottom wall 408, and a side wall 409 extending between the top opening 407 and the bottom wall 408. In some embodiments, the containers 405 may not include a side wall 409. The side wall 409 can be configured to retain the fuel 406 within the container 405 and to reduce friction between the fuel 406 and the side wall 412 of the container 402. In some embodiments, each container 405 can include between 25 and 200 grams of water reactive fuel 406. For example, in some embodiments, the containers 405 can include 50-200 grams of water reactive fuel 406. For example, in some embodiments, the container 405 can contain between 40-60, 50-70, 60-80, 70-90, 80-100, 90-110, 100-120, 110-130, 120-140, 130-150, 140-160, 150-170, 160-180, 170-190, 180-200, 190-210, or 200-220 grams of fuel water reactive fuel 406, although the container 405 can be configured to contain more or less amounts of water reactive fuel 406 without limit. In some embodiments, the size of the container 405, the size of the container 402, and/or the amount of water reactive fuel 406 can depend on the size of the reactor vessel 422 and/or an amount of reaction medium (e.g., water) configured in the reactor vessel 422. In some embodiments, the length L of the container 402 can be configured retain a predetermined number of containers 405 and/or a predetermined amount of the water reactive fuel 406.

In some embodiments, adjacent containers 405 can be positioned within the container 402 in a vertically-stacked configuration and can be separated from one another by the bottom wall 408. In some embodiments, a small gap may be configured between adjacent containers 405. In other embodiments, the containers 405 may be directly contacting and positioned atop one another without a gap between the adjacent containers 405.

In some embodiments, the containers 405 can include a gasket, such as an O-ring configured on the top opening 407 or the bottom wall 408 of the container 405. For example, as shown in FIG. 4, the container 405C includes a first gasket 410 extending circumferentially around the top opening 407 and a second gasket 411 extending circumferentially around the bottom wall 408. The diameter of the containers 405 and the gaskets 410, 411 can be sized to sealably engage the inner surface of the side wall 412 of the container 402. In this way, the containers 405 can be vertically stabilized for axial travel within the container 402 and to avoid the container 405 flipping or becoming offset from a longitudinal axis of the container 402. In some embodiments, the gaskets 410 and 411 can extend longitudinally along the side wall 409 of the containers 405. The gaskets 410, 411 can provide a sealable interface with the reaction vessel when the fuel storage assembly 400 is releasably coupled thereto. The gaskets 410, 411 can be configured to retain the fuel 406 within the container 405 such that the fuel 406 does not escape the container 405 to prohibit sealable coupling of the container 402 with the reactor vessel due to fuel 406 migrating from the container 405 into a sealing region formed between the container 402 and the reactor vessel.

The second end 404 of the container 402 can include a plate 413 or the like configure to receive an axial force and to translate the force longitudinally to the containers 405 in order to cause the containers 405 to advance longitudinally within the container 402. For example, when the container 402 is coupled with a reactor vessel, the plate 413 can receive a force causing the containers 405 to advance longitudinally through the container 402 and into the reactor vessel. The plate 413 can include gaskets 414 and/or 415 extending circumferentially therearound. The gasket 414, 415 can be configured to sealably couple the plate 413 with the side wall 412 of the container 402. The gaskets 414, 415 are configured to maintain the second end 404 of the container 402 in a water-proof state to prevent exposure of any of the fuel 406 to water prematurely before deployment into a reactor vessel. The plate 413 can also include an injector port 416 at which the force can be received from a fluid supply 417 that can be fluidically coupled to the injector port 416. In some embodiments, the fluid supply 417 can be a high-pressure water supply, a high-pressure air supply PAS, or a pneumatic injection device or system PIS.

In some embodiments, the fluid supply 417 can be coupled to the injector port 416 via a fluid metering device 418. The fluid metering device 418 can include a plurality of electrically actuated valves configured to supply a precise amount of fluid to the injector port 416 to cause the desired movement of the containers 405 within the container 402, such that responsive to a single metering event or fluid-dose controlled by the fluid metering device 418, the plate 413 is configured to translate axially within the container 402 such that a single container 405 (and the fuel 406 contained therein) is released from the container 402 and into the reactor vessel for Hydrogen generation. In some embodiments, the fluid metering device 418 can include a syringe or similar fluid metering container configured to receive fluid from a fluid source. Once received, the fluid can be pushed out of the syringe into a different destination volume, such as the distal end of the container 402 at which injector port 416 is configured relative to plate 413. In some embodiments, the syringe can contain the same quantity of water as is occupied by one container 405. If the destination volume is the injector port 416 of plate 413 within the container 402, and the volume of the syringe equals the volume occupied by one container 405, then the syringe can be used to accurately and reliably dispense one container 405 at a time into the reactor vessel 422. In some embodiments, the fluid metering device 418 can include a plurality of electrically actuated valves. For example, two valves can be configured on each end of the fluid metering device 418 to act as a 3-way valve assembly (e.g., to direct water flow either into or out of each end of the syringe). In some embodiments, at least one valve can be configured for initialization (e.g., purging air out) of the system. In such embodiments, the at least one valve can be configured to redirects the water back to the fluid supply 417. In some embodiments, at least one additional valve can be configured to directs fluid to the container 402 having fuel-laden containers 405 therein for insertion into the reactor vessel 422.

In some embodiments, for example, as shown in FIG. 5, a linear actuator 419 including an electrically operated and controlled motor can be configured to supply force to the plate 413. In some embodiments, the linear actuator 419 can include be operably coupled to a computing device 421 including a data processor, a memory, and a controller configured to execute non-transitory, computer-readable instructions stored in the memory, which can cause the data processor and/or the controller to generate control signals for actuating the linear actuator 419. In some embodiments, the linear actuator 419 can be a manual actuator configured to apply a force to plate 413 responsive to a user manipulating the manual actuator. The linear actuator 419 can also include an encoder configured to determine and control an amount of travel of an actuating mechanism 420 of the linear actuator 419. As such, precise adjustments in the linear movement A of actuating mechanism 420 relative to the plate 413 can be controlled to ensure a desired amount of movement B is imparted to the containers 405 (and thus fuel 406) so as to cause the containers 405 (and the fuel 406 therein) to translate from the container 402 and into the reactor vessel 422.

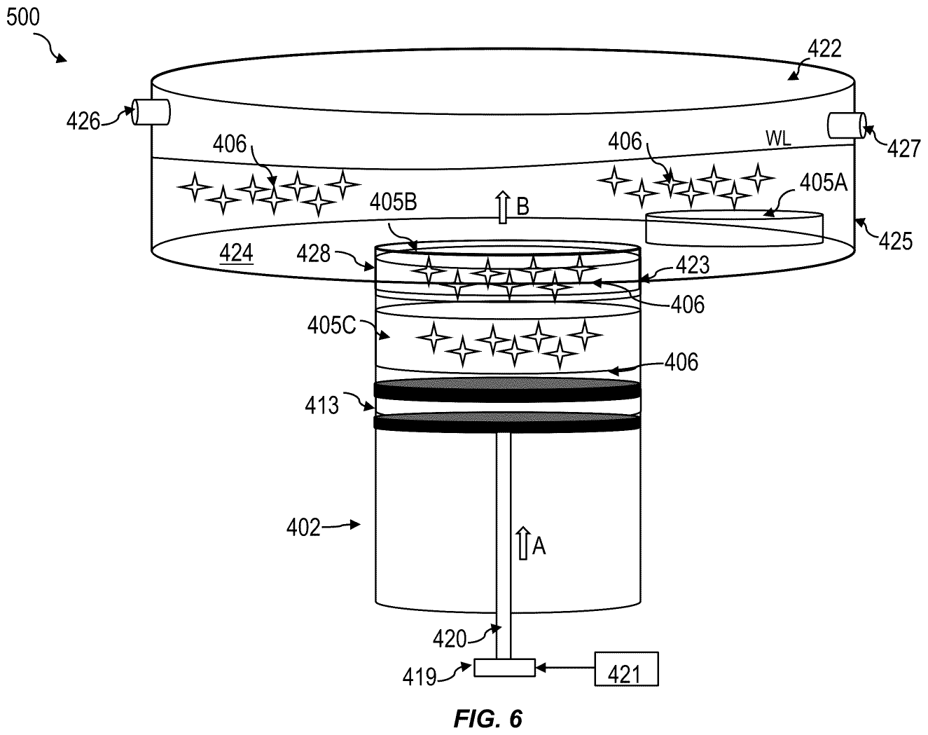

Turning to FIGS. 5-6, the fuel storage assembly 402 is illustrated coupled to the reactor vessel 422 for the purpose of demonstrating the provision of fuel 406 from the containers 405 and into the reaction vessel 422 for the production of Hydrogen. In the configuration of the system 500 shown in FIG. 5, the first end 403 of the fuel storage assembly 402 is coupled to an opening 423 of a wall 424 of the reactor vessel 422 having a water line WL. In the illustrated embodiment, the fuel storage assembly 402 is coupled vertically to the opening 423 formed in a bottom wall 424 of the reactor vessel 422. In some embodiments, the fuel storage assembly 402 can be coupled horizontally to an opening in the side wall 425 of the reactor vessel 422 above or below the water line WL. In some embodiments, the fuel storage assembly 402 can be coupled vertically to a top wall of the reactor vessel 422 above the water line WL. In some embodiments, the fuel storage assembly 402 can be configured in an inverted position relative to a wall of the reactor vessel 422.

Although only a cross-sectional portion of the reactor vessel 422 is illustrated in FIGS. 5-6, it will be understood that the reactor vessel 422 is a sealed container containing a reaction medium, such as water having a water line WL illustrating a surface of the water in the reactor vessel 422. The reactor vessel 422 can include an opening 423 at which the fuel storage assembly 402 can be received, at least one fill port 426 configured to receive a reaction medium in the reaction vessel 422, and at least one collection port 427 at which generated Hydrogen can be collected from the reaction vessel 422. In some embodiments, the reactor vessel 422 can include multiple openings 423, multiple fill ports 426, and/or multiple collection ports 427. For example, in some embodiments, the reactor vessel 422 can include 1, 2, 3, 4, 5, 6, 7, or 8 openings 423 arranged within a wall of the reactor vessel, such as the walls 424 or 425. In some embodiments, the wall 424 or 425 of the reactor vessel can include a removable m portion in which the opening 423 can be located.

The reactor vessel 422 can include a collar 428 positioned in the opening 423 of the reactor vessel 422 at which the first end 403 of the container 402 is coupled to the wall 424 of the reactor vessel 422. The collar 428 can include a groove or slot extending at least partially circumferentially around the collar 428 and configured to receive the flange 433 positioned at the first end 403 of the container 403 in twist-lock engagement. In some embodiments, the flange 433 and the collar 428 can be configured to couple to one another via a snap-fit engagement mechanism. In some embodiments, the collar 428 can be coupled to the wall 424 with a plurality of attachment mechanisms, such as bolts, welds, or threaded couplings. The collar 428 can also include a seal configured to seal the opening 423 to prevent reaction medium from escaping the reactor vessel 422 prior to coupling of the container 402 to the collar 428. Responsive to a first container 405 translating through the collar 428, the seal is configured to unseal so as to allow the water reactive fuel 406 retained within the container 405 to be dispersed into the reactor vessel 422. In some embodiments, the seal can be configured at the first end 403 of the container 402 and can unseal responsive to a container 405 being translated through the first end 403 of the container 402. For example, as shown in FIG. 4, the seal 434 is configured at the first end 403 of the container 402 in a sealed configuration. The seal 434 will become unsealed responsive to advancing at least one of containers 405 through the first end 403. In some embodiments, the seal 434 can include a thin plastic or metal (e.g., foil) seal. The seal 434 can be retained at the first end 403 of the container 402 using an adhesive, ultrasonic welding, lamination, or a mechanical coupling mechanism, such as a clamp. In some embodiments, as shown in FIG. 4, a container 405 that is positioned proximally to the first end 403 of the container 402 (e.g., container 405A) can include one or more protruding elements 435 protruding from the top opening 407 to puncture the seal 434 as the container 405A is advanced through the first end 403. In some embodiments, the protruding element 435 can include a needle protruding from an upper surface of the side wall 409. In some embodiments, the protruding element 435 can include a plurality of protruding elements 435 protruding from an upper surface of the side wall 407 that can form a serrated edge at the top opening 407 of a container 405.

The collar 428 and its corresponding seal (or the seal 434 arranged at the first end 403 of container 402) can advantageously allow rapid removal and reloading of fuel storage assemblies 402 without risk of losing reaction medium and/or fuel 406 from the opening 423 of the reactor vessel 422 as well as preventing containers 405 (and fuel 406) from being prematurely released from the container 402 or wetted within the container 402.

In operation, as shown in FIG. 5, the linear actuator 419 can be configured to cause the actuation mechanism 420 to translate in direction A so as to cause a force to be applied to plate 413. The applied force can be translated from the plate 413 to the containers 405 configured in a stacked arrangement in the container 402. The containers 405 can translate toward the opening 423 of the wall 424 of the reactor vessel 422 and through the collar 423 into the reactor vessel 422. The water-proof configuration of the collar 428 and container 402 coupled thereto can prevent the reaction medium and fuel 406 from escaping the reactor vessel 422 during the insertion of the containers 405 into the reactor vessel 422.

As shown in FIG. 6, responsive to the linear actuator 419 causing the actuation mechanism 420 to translate in direction A causing containers 405 to advance within the container 402 toward the opening 423, a container 405 can be advanced into the reactor vessel 422 in direction B so that the fuel 406 contained in the container 405 can be wetted by the reaction medium to generate Hydrogen. For example, as shown in FIG. 6, the linear actuator 419 has actuated the actuation mechanism 420 to translate against plate 413 in the direction A. The stacked arrangement of the containers 405 in the container 402 can transfer the applied force from plate 413 to cause container 405A to be introduced into and through the collar 428 formed in the opening 423 of the wall 424 of the reactor vessel 422. As such the fuel 406 of container 405A is exposed to the reaction medium beneath the water line WL and can be wetted to initiate Hydrogen production within the reactor vessel 422.

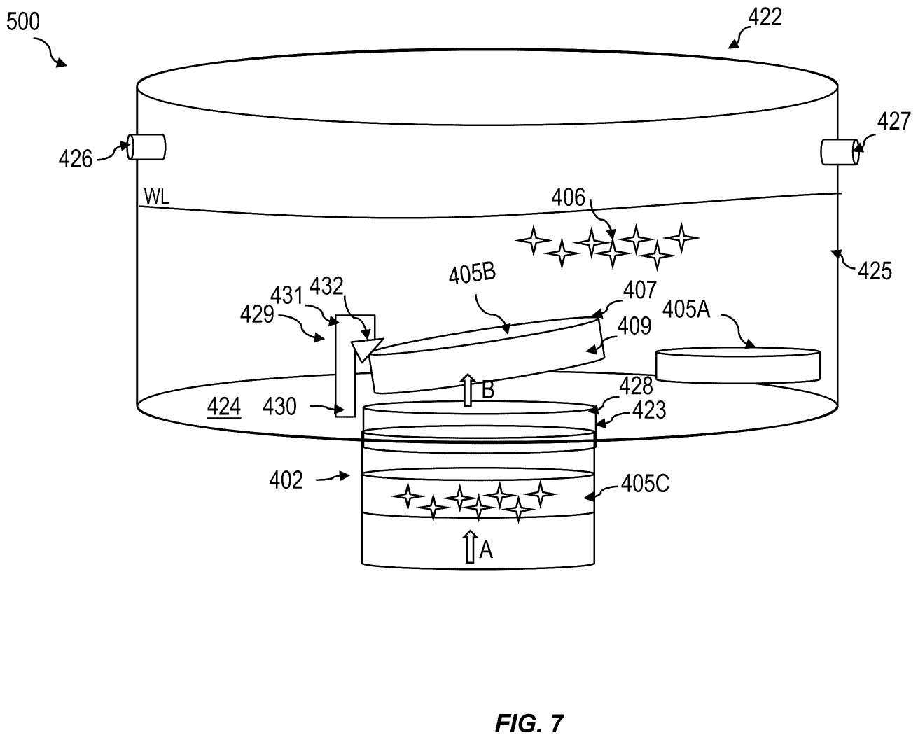

As shown in FIG. 7, the linear actuator 419 has continued to advance the actuator mechanism 420 in direction A such that container 405A has been displaced from the collar 428 and the fuel 406 in container 405A has been dispersed into the reaction medium of the reactor vessel 422. Container 405 B has been translated in direction B to be positioned in the collar 428 and its fuel 406 is exposed to the interior of the reactor vessel 422 and the reaction medium therein, which can initiate Hydrogen production from the fuel 406 contained in the container 405B. The linear actuator 419 can continue to apply force to plate 413 in direction A to advance additional containers 405 through the container 402 and into the collar 428 where the fuel 406 contained in respective containers can be wetted and dispersed into the reaction medium for Hydrogen generation.

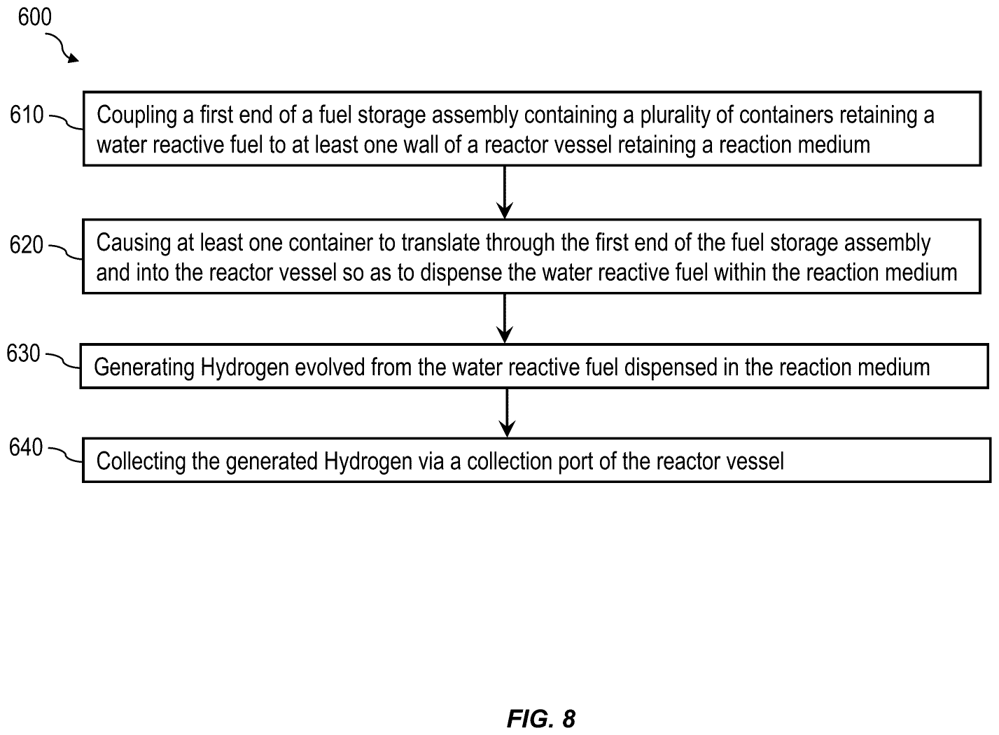

As shown in FIG. 8, the reactor vessel 422 can include a displacement mechanism 429 configured to displace containers 405 from the collar 428 so as not to block subsequent containers 405 as they are advanced in direction B through the collar 428 and into the reactor vessel 422. The displacement mechanism 429 can be bolted, welded, or similarly coupled to the walls of the reactor vessel at the location where the container 402 is coupled thereto. In the example embodiment shown in FIG. 8, the displacement mechanism 429 is shown coupled to the wall 424 and is positioned adjacent to the opening 423, although in other embodiments, the displacement mechanism 429 can be positioned in wall 425 or a top wall of the reactor vessel 422. The displacement mechanism 429 includes a protruding portion 430 that extends away from the wall 424 and is axially parallel with a longitudinal axis extending through the collar 428 and the container 402 coupled thereto. The displacement mechanism can include an engaging portion 431 coupled to the protruding portion 430. The engaging portion 431 can be configured transversely from the protruding portion 430 and can include an engagement member 432 configured to engage the side wall 409 of the container 405 at the top opening 407. The engagement member 432 can be configured to cause the container 405 to displace from the collar 428 so as to not block the opening of the collar 428 as subsequent containers 405 are advanced therethrough. As shown in FIG. 8, the engagement member 432 includes an angled surface configured to displace the container 405B from the collar 428 as the container 405C is advanced in direction B through the container 402 and into the collar 428. Container 405A is shown as having been already displaced prior to the displacement of container 405B.

FIG. 9 illustrates an example embodiment of a process diagram describing a method 600 for generating Hydrogen from a water reactive fuel dispensed into a reaction medium according to the systems and methods described herein, such as the systems 100, 300, and 500 herein. Steps of the method 600 can be performed sequentially or non-sequentially and one or more steps can be performed iteratively.

At 610, a first end 403 of a fuel storage assembly 400 containing a plurality of containers 405 retaining a water reactive fuel 406 can be coupled to at least one wall 424 of a reactor vessel 422 containing a reaction medium therein. For example, a flange 433 at the first end 403 of the container 402 can be received within a collar 428 positioned in an opening 423 of the wall 424 of the reactor vessel 422. The flange 433 can be configured to twist-lock within the collar 428 so as to couple the container 402 to the reactor vessel 422.

At 620, at least one container 405 can be translated through the first end 403 of the fuel storage assembly 400 and into the reactor vessel 422 so as to dispense the water reactive fuel 406 within the reaction medium. For example, an actuation force can be supplied to a plate 413 at the second end 404 of the container 402 in a direction A to cause a container 405 containing the water reactive fuel 406 to pass from within the container 402, through the first end 403 thereof, and though the opening 423 of the reactor vessel 422 to be dispensed within the reaction medium retained in the reactor vessel 422. In some embodiments, the water reactive fuel 406 can be dispensed into the reaction medium from above or below a water line WL corresponding to a level of the reaction medium retained in the reactor vessel 422. In some embodiments, the actuation force can be provided via a linear actuator, a pressurized air supply PAS, or a pneumatic injection device or system PIS.

Hydrogen can be generated from the water reactive fuel 406 dispensed in the reaction medium at 630 as described herein according to the reaction equation described previously. At 640, the generated Hydrogen can be collected from the reactor vessel 422 via a collection port 427 configured in a wall of the reactor vessel, such as the wall 425.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
a reactor vessel having at least one wall and retaining a reaction medium therein;
a fuel storage assembly releasably coupled an opening in the at least one wall of the reactor vessel, the fuel storage assembly comprising water reactive fuel configured to react with the reaction medium and to generate Hydrogen; and
an actuator coupled to the fuel storage assembly, the actuator configured to supply an actuation force to the fuel storage assembly to cause the water reactive fuel to be dispensed from the fuel storage assembly, through the opening in the at least one wall, and into the reactor vessel.

2. The system of claim 1, wherein the fuel storage assembly comprises a tube having an open first end and a closed second end opposite the open first end, the open first end having a flange therearound configured to releasably couple the open first end to a collar positioned in the opening in the at least one wall of the reactor vessel.

3. The system of claim 2, wherein the closed second end includes a plate configured to couple with the actuator and to receive the actuation force, the plate comprising a first side and a second side opposite the first side, at least one of the first side and the second side comprising a gasket therearound configured to seal the plate within the fuel storage assembly.

4. The system of claim 1, wherein the actuator comprises one of a linear actuator, a pressurized air supply, or a pneumatic injection device.

5. The system of claim 1, wherein the fuel storage assembly comprises a plurality of containers, each container retaining a predetermined amount of the water reactive fuel configured to form the generated Hydrogen when dispensed from the fuel storage assembly into the reaction medium.

6. The system of claim 5, wherein at least one container of the plurality of containers includes an open first end, a bottom wall opposite the open first end, and a side wall extending between the open first end and the bottom wall.

7. The system of claim 6, wherein at least one of the open first end and the bottom wall comprise a gasket therearound configured to seal the water reactive fuel within the at least one container within the fuel storage assembly.

8. The system of claim 5, wherein the predetermined amount of the water reactive fuel is between 50 grams and 100 grams.

9. The system of claim 1, wherein the at least one wall of the reactor vessel to which the fuel storage assembly is coupled includes a removable flange portion configured to remove the at least one wall from the plurality of walls of the reactor vessel.

10. The system of claim 1, wherein the at least one wall further comprises a displacement mechanism positioned adjacent to the opening in the at least one wall of the reactor vessel and protruding into the reactor vessel.

11. The system of claim 10, wherein the displacement mechanism comprises an engagement member configured to axially displace a container of the fuel storage assembly from the opening in the at least one wall of the reactor vessel.

12. The system of claim 1, wherein the actuator is configured to supply the actuation force responsive to a control signal received from a controller operably coupled to the actuator.

13. An apparatus, comprising:
a cylindrical tube having a first end and a closed second end opposite the first end, the cylindrical tube comprising a plurality of cylindrical containers arranged in a stacked configuration within the cylindrical tube and retaining a water reactive fuel therein, each cylindrical container having an open first end and a closed second end opposite the open first end, at least one of the open first end and the closed second end of a first cylindrical container including a gasket therearound configured to seal the water reactive fuel of a second cylindrical container adjacent to the first cylindrical container within the cylindrical tube.

14. The apparatus of claim 13, wherein at least one cylindrical container of the plurality of cylindrical containers retains between 50 and 100 grams of the water reactive fuel therein.

15. The apparatus of claim 13, wherein the closed second end includes a plate having a first wall and a second wall forming the closed second end of the cylindrical tube, the second wall configured to receive an actuation force to cause at least one cylindrical container to advance through the cylindrical tube toward the first end thereof.

16. The apparatus of claim 15, wherein the actuation force is supplied via at least one of a linear actuator, a pressurized air supply, and a pneumatic injection system.

17. The apparatus of claim 13, wherein the first end of the cylindrical tube comprises a flange extending circumferentially therearound, the flange configured to couple the cylindrical tube with a wall of a reactor vessel comprising a reaction medium.

18. The apparatus of claim 17, wherein the water reactive fuel is configured to generate Hydrogen when dispensed from a cylindrical container that has translated through the first end of the cylindrical tube and into the reactor vessel so as to contact the reaction medium.

19. The apparatus of claim 13, wherein the first end of the cylindrical tube further comprises a seal extending thereacross to seal the water reactive fuel within the cylindrical tube, the seal configured to unseal responsive to translating a cylindrical container through the first end.

20. A method, comprising:
coupling a first end of a fuel storage assembly containing a plurality of containers retaining a water reactive fuel to at least one wall of a reactor vessel retaining a reaction medium;
causing at least one container to translate through the first end of the fuel storage assembly and into the reactor vessel so as to dispense the water reactive fuel within the reaction medium;
generating Hydrogen gas evolved from the water reactive fuel dispensed in the reaction medium; and
collecting the generated Hydrogen gas via a collection port of the reactor vessel.
